(19) United States
(12) Patent Application Publication
(10) Pub. No.: US 2006/0007111 A1
(43) Pub. Date: Jan. 12, 2006

(54) Liquid crystal display device having good image quality

(75) Inventors: Jeong-Min Moon, Gyeonggi-Do (KR); Hee-Jeong Park, Gyeonggi-Do (KR)

Correspondence Address: HELLER EHRMAN WHITE & MCAULIFFE LLP, 1717 RHODE ISLAND AVE, NW, WASHINGTON, DC, 20036-3001, US

(73) Assignee: LG.PHILIPS LCD CO., LTD., Seoul (KR)

(21) Appl. No.: 11/165,176

(22) Filed: Jun. 24, 2005

(30) Foreign Application Priority Data
Jun. 29, 2004 (KR) 10-2004-0049788

(51) Int. Cl. G09G 3/36

(52) U.S. Cl. 345/102

(57) ABSTRACT

A liquid crystal display device includes a liquid crystal display panel, a light source having red, green and blue light emitting devices for supplying light to the liquid crystal display panel, the light source being divided into a plurality of regions, and a driving unit for separately driving red, green and blue light emitting devices in each region.

The present invention claims the benefit of Korean Patent Application No. 49788/2004 filed in Korea on Jun. 29, 2004, which is hereby incorporated by reference in its entirety.

### BACKGROUND OF THE INVENTION

1. Field of the Invention

The present invention relates to a liquid crystal display device, and more particularly, to a liquid crystal display device and a driving method thereof.

2. Description of the Related Art

With the recent development of various portable electronic devices, such as mobile phones, personal digital assistants (PDAs), and notebook computers, demand for light weight, thin profile, small flat panel display devices, which can be used as displays in such devices, is increasing. Ongoing research is occurring in flat panel display devices, including liquid crystal display (LCD) devices, plasma display panel (PDP) devices, field emission display (FED) devices, and vacuum fluorescent display (VFD) devices. Of these different devices, the LCD devices are most actively being developed because of the simple mass-production techniques and their simple driving systems that enable the production of an affordable high quality picture display.

Such a liquid crystal display device is a transmission type display device that displays a desired image on a screen by controlling the amount of light transmitting through the liquid crystal layer by refraction anisotropy of liquid crystal molecules. Accordingly, a back light, which is a light source transmitting through a liquid crystal layer in order to display an image, is installed in the liquid crystal display device.

FIG. 1 is a plan view schematically illustrating a structure of a related art liquid crystal display device. FIG. 2 is a cross-sectional view illustrating the structure of the related art liquid crystal display device shown in FIG. 1. As illustrated in FIG. 1, a plurality of gate lines 12 and data lines 14, which are arranged horizontally and vertically, are formed on a liquid crystal display panel 10 to define pixels 11. A thin film transistor 16, a switching device, is disposed within each pixel. The thin film transistor 16 is switched when a scanning signal is inputted through the gate line 12 such that a signal is inputted through the data line 14 to the liquid crystal layer 18.

In FIG. 1, the reference mark Cst is a storage capacitor, which serves to maintain the inputted data signal until a next scanning signal is supplied. Liquid crystal molecules are operated by the signal supplied to the liquid crystal layer 18. As the liquid crystal molecules are operated, light transmitted by the liquid crystal layer 18 passes through a color filter so that colors of the liquid crystal display device are implemented.

In reference to FIG. 2, a pixel structure of such a liquid crystal display device will be described. As illustrated therein, a gate electrode 31 formed of metal is formed on a first substrate 20 formed of a transparent insulating material, such as glass. A gate insulating layer 22 is deposited over the entire substrate 20 having the gate electrode 31 thereon. A semiconductor layer 33 is formed on the gate insulating layer 22, and source/drain electrodes 35 are formed on the semiconductor layer 33.

A passivation layer 24 is formed on the source/drain electrodes 35 and over the entire substrate 20. A pixel electrode 37 is formed on the passivation layer 24. The pixel electrode is formed of a transparent conductive material, such as ITO (Indium Tin Oxide) or IZO (Indium Zinc Oxide), and is electrically connected with the source/drain electrodes 35 of the thin film transistor through a contact hole formed in the passivation layer 24.

A black matrix 42 is formed on a second substrate 40 between the pixels and over the TFT regions in the pixels. More particularly, the black matrix is a light shielding layer for preventing deterioration in image quality, which is caused by light leakage through a non-image displaying region. A color filter layer 44 for implementing a color is formed in an image displaying region. Although not illustrated in FIG. 2, a common electrode formed of transparent metal, such as ITO or IZO, is formed on the black matrix 42 and the color filter layer 44.

Liquid crystal is injected between the first substrate 20 where the thin film transistor is formed and the second substrate 40 where the color filter substrate 44 is formed to thereby form a liquid crystal layer 50. In addition, although not illustrated in FIG. 2, polarization plates for polarizing light are attached to the first substrate 20 and to the second substrate 40. A back light 60 is provided at a lower portion of the first substrate 20 and supplies light to the liquid crystal layer 50. Although not illustrated in detail in FIG. 2, the back light 60 includes a lamp for generating light, a light guide plate for guiding the light generated from the lamp to a liquid crystal display panel, and an optical sheet for improving efficiency of light guided by the light guide plate.

The lamp is typically a CCFL (Cold Cathode Fluorescent Lamp) or an EEFL (External Electrode Fluorescent Lamp). However, the CCFL and the EEFL have a low color representation and a low response speed. Further, their brightness is low.

### SUMMARY OF THE INVENTION

Accordingly, the present invention is directed to a to a liquid crystal display device and a driving method thereof that substantially obviates one or more of the problems due to limitations and disadvantages of the related art.

An object of the present invention is to provide a liquid crystal display device capable of improving image quality by implementing R, G and B colors having different brightness according to each region or according to time.

Another object of the present invention is to provide a liquid crystal display device capable of implementing a variety of grey scales.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a liquid crystal display device including a liquid crystal display panel, a light source having red, green and blue light emitting devices for supplying light to the liquid crystal display panel, the light source being divided into a plurality of regions, and a driving unit for separately driving red, green and blue light emitting devices in each region.

In another aspect, a liquid crystal display device includes a liquid crystal display panel, a light source formed of red, green and blue light emitting devices for supplying light to the liquid crystal display panel, and a driving unit for locally controlling brightness of red, green and blue colors by locally and independently driving red, green and blue light emitting devices of the light source.

In another aspect, a liquid crystal display device includes a liquid crystal display panel, a light source having at least three different colors of light emitting devices for supplying light to the liquid crystal display panel, a driving unit for locally controlling brightness of the at least three different colors of light emitting devices, the driving unit including a timing controlling unit for generating a timing signal according to a video signal, and a pulse width modulation controlling unit for outputting driving signals to the at least three different colors of light emitting devices according to the timing signal inputted from the timing controlling unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a plan view schematically illustrating a structure of a related liquid crystal display device;

FIG. 2 is a cross-sectional view illustrating the structure of the related art liquid crystal display device shown in FIG. 1;

FIG. 3A is an exploded perspective view illustrating a structure of a liquid crystal display device in accordance with an embodiment of the present invention;

FIG. 3B is an exploded cross-sectional view illustrating the structure of the liquid crystal display device of FIG. 3A in accordance with an embodiment of the present invention;

FIG. 4 is a view illustrating an LED unit which is divided into a plurality of regions;

FIG. 5 is a view illustrating a structure of a LED driving unit of the liquid crystal display device in accordance with an embodiment of the present invention; and

FIGS. 6A to 6C are waveform views showing signals supplied to the LED unit of the liquid crystal display device in accordance with an embodiment of the present invention.

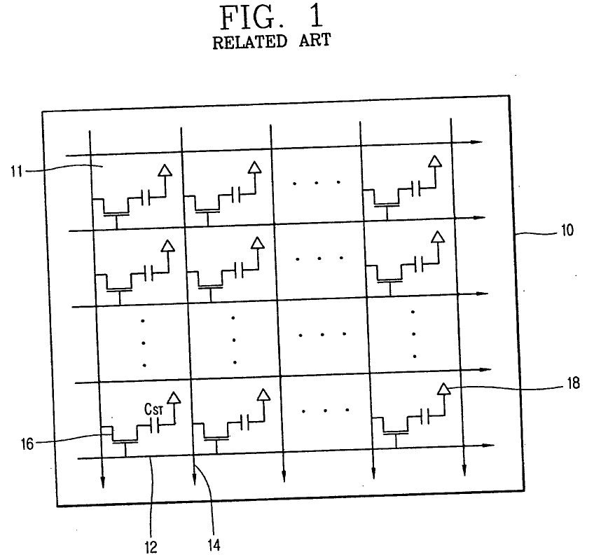

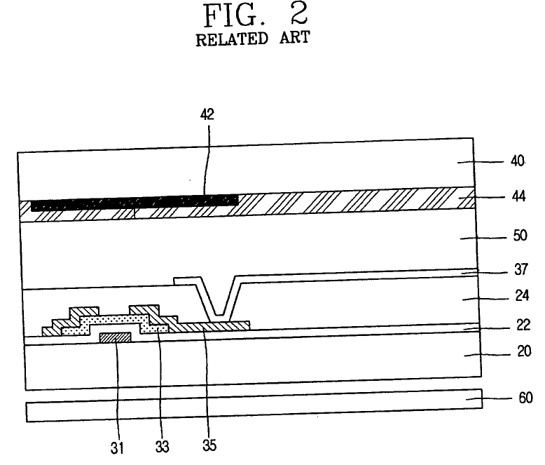

### DETAILED DESCRIPTION OF THE PREFERRED EMBODIMENTS

Reference will now be made in detail to the preferred embodiments of the present invention, examples of which are illustrated in the accompanying drawings.

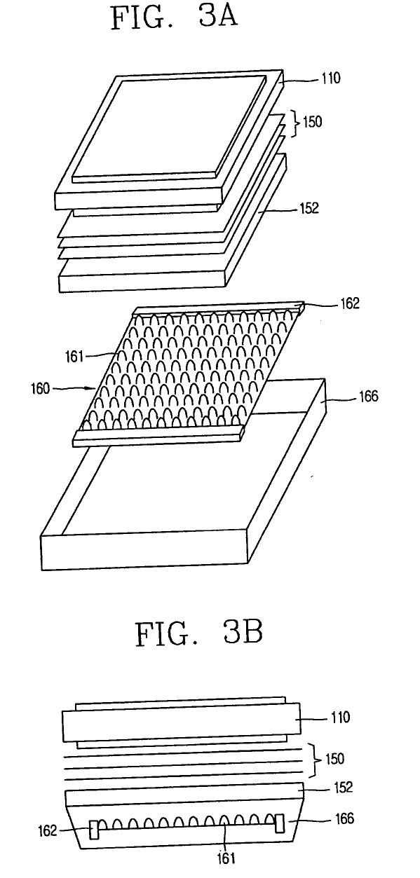

Recently, research on a method for using a light emitting device (LED) as a back light has been actively conducted in order to overcome the disadvantages of either a CCFL or an EEFL. The LED increases color representation and improves brightness in the emission of monochromatic light. In addition, the LED has a fast response because it has a rapid response characteristic. FIGS. 3A and 3B illustrate a structure of a liquid crystal display device in accordance with an embodiment of the present invention, where an LED is used in a back light. FIG. 3A is an exploded perspective view and FIG. 3B is an exploded cross-sectional view of FIG. 3A.

As illustrated in FIGS. 3A and 3B, a liquid crystal display device in accordance with an embodiment of the present invention includes a liquid crystal display panel 110 in which full color displays are implemented. More particularly, a back light unit is provided with an LED unit 160 having a plurality of red (R), green (G) and blue (B) LEDs 161 thereon for irradiating light onto the liquid crystal display panel, and an LED driving unit 162 for driving the R, G and B LEDs 161. Although not illustrated therein, a liquid crystal display panel 110 includes a thin film transistor substrate on which a thin film transistor and an electrode pattern, such as a pixel electrode or the like is formed, a color filter substrate on which a color filter is formed, and a liquid crystal layer formed between the thin film transistor substrate and the color filter substrate.

The back light unit includes the LED unit 160 provided with the plurality of LEDs 161 emitting R, G and B monochromatic light, a housing 166 receiving the LED unit 160, a diffusing plate 152 arranged above the LED unit 160 and diffusing light emitted from the LEDs 161, and an optical member 150 arranged above the diffusing plate 152 and improving efficiency of light, which is diffused from the diffusing plate 152 and made incident upon the liquid crystal display panel 110.

The diffusion plate 152 is obtained by coating both sides of a film formed of transparent resin with a light diffusion material. The diffusion plate 152 allows light emitted from the plurality of R, G and B LEDs 161 to be made incident toward the liquid crystal display panel 110 at a wide angle. The optical member 150 further diffuses light diffused by the diffusing plate 152 and simultaneously makes diffused light straight, thereby improving front brightness and minimizing power consumption.

The R, G and B LEDs 161 are arranged on the LED unit 160 at regular intervals and make light of R, G and B incident upon the liquid crystal display panel 110. The R, G and B LEDs 161 may be arbitrarily arranged. For instance, the LEDs 161 may be arranged in the order of RGB, RBG or GRB. In other words, an arrangement of the R, G and B LEDs 161 may be randomly distributed.

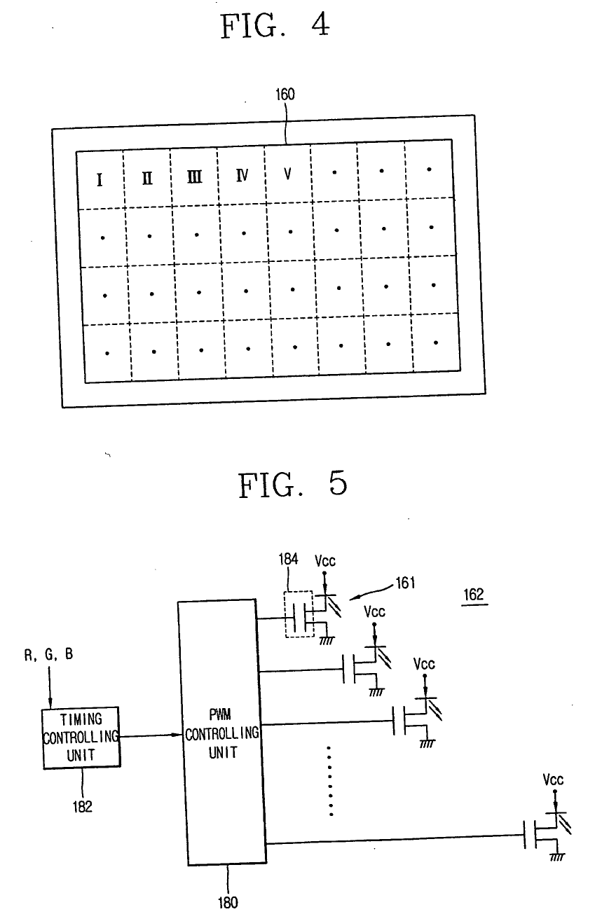

Referring to FIG. 4, the LED unit 160 is divided into a plurality of regions. Such division is performed to vary brightness of white light and brightness of R, G and B colors according to each region. In the related art, when LEDs are used as the back light as well as when a lamp such the CCFL or the EEFL is used as the back light, the same signals are inputted to the LEDs provided on the back light unit and therefore light is emitted toward the panel with the same uniform brightness. Accordingly, only the brightness of an entire screen of the liquid crystal display device can be controlled. No local or regional control of the brightness is allowed. Thus, there is a limit in implementing images with vivid color in the related art.

On the other hand, in embodiments of the present invention, brightness can be locally controlled by dividing a back light into a plurality of regions and independently driving the LEDs 161 in the divided regions. Besides, in embodiments of the present invention, since not only can brightness of white light be independently controlled according to each region but also monochromatic light of R, G or B can be independently controlled such that more vivid images can be locally displayed. In addition, controlling of R, G or B monochromatic light according to each region allows brightness of each monochrome R, G and B primary colors to be freely controlled, thereby making a rich color display and implementing a variety of grey scales for a variety of colors.

The LED unit 160 can be divided into 32 regions, but it can be divided into any other appropriate number of regions according to conditions, such as the area of the screen, resolution or the like. As described, in order to drive the R, G and B LEDs 161 according to the regions, different signals should be supplied to the R, G and B LEDs 161 provided in each of the regions in the LED driving unit 162. An LED driving unit 162 capable of supplying will now be described.

FIG. 5 is a view illustrating a structure of a LED driving unit of the liquid crystal display device in accordance with an embodiment of the present invention. As illustrated in FIG. 5, the LED driving unit 162 includes a timing controlling unit 182 for outputting a timing signal corresponding to each video signal and a pulse width modulation (PWM) controlling unit 180 receiving the timing signal from the timing controlling unit 182 and supplying driving signals to the LEDs 161 of each region of the LED unit 160. A switch 184 is provided between the PWM controlling unit 180 and the LED 161 to control a driving signal supplied to the LED 161.

The timing controlling unit 182 generates a timing signal according to a characteristic of the inputted video signal. In the liquid crystal display device in embodiments of the present invention, R, G and B colors have different brightness and image data values corresponding to the divided regions of the liquid crystal display panel 110. For example, when the same colors are displayed throughout a plurality of regions, a high purity color has a high brightness value and image data of light grey and a low purity color has a low brightness value and image data of relatively dark grey. The timing controlling unit 182 generates R, G and B controlling signals having R, G and B brightness values and image data, which vary according to an image of each region, and supplies the controlling signals to the PWM controlling unit 180.

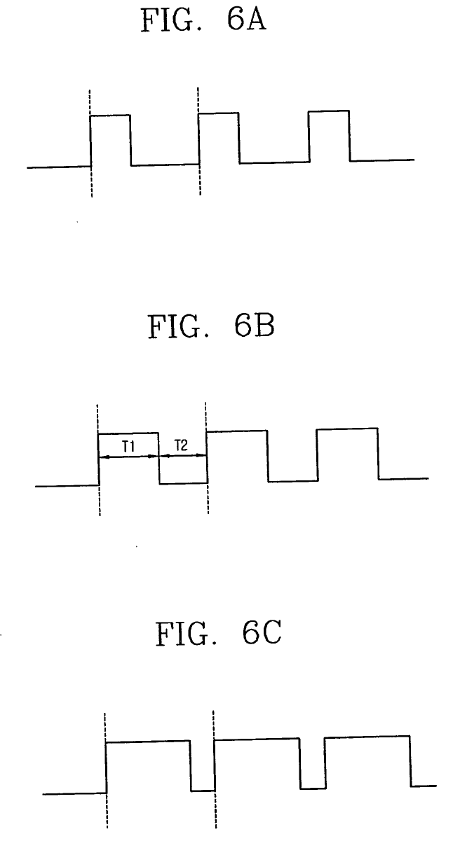

The PWM controlling unit 180 receives the control signal from the timing controlling unit 182 and generates a driving signal corresponding to the timing signal, and supplies the generated driving signal to the LEDs 161. FIGS. 6A to 6C are exemplary views of signals supplied to the R, G and B LEDs 161, respectively, of a plurality of regions formed on the back light unit 160 of embodiments of the present invention, in which signals having different sizes being supplied to red LEDs of each region are illustrated.

As illustrated FIGS. 6A to 6C, the intensity of electric current applied to an LED is regulated by controlling the duty ratio of a signal. In one embodiment of the present invention, the waveforms shown in FIGS. 6A-6C can be applied to adjacent regions, respectively. For example, when the signal illustrated in FIG. 6A is supplied to a red LED of the first region (I) of the LED unit 160 illustrated in FIG. 4 and signals illustrated in FIGS. 6B and 6C are supplied to red LEDs of the second region (II) and the third region (III), respectively, which are adjacent to the first region (I), the duty ratio of the signal being supplied to the red LED of the third region (III) is the highest. Thus, the intensity of electric current applied to the red LED of the third region (III) is the highest and the intensity of electric current applied to the red LED of the first region (I) is the lowest. Such a difference in the intensity of electric current causes a difference in the amount of light emitted from the supplied LED. As a result, a difference in purity and brightness of red colors in the first region (I), the second region (II) and the third region (III) occurs, thereby implementing vivid images. Here, spatial vividness of images is improved by supplying different signals to spatially adjacent regions.

In another embodiment, the waveforms shown in FIGS. 6A-6C can be applied sequentially to a specific region of the LED unit 160. For example, when the signals illustrated in FIGS. 6A to 6C are ones inputted sequentially (or at regular time intervals) to a red LED of a specific region, since electric current of different intensity is applied to the same red LED according to time, purity and brightness of a red color change with time, thereby implementing vivid images Here, temporal vividness of images is improved by supplying temporally different signals. The description above with regard to the red LED is also applicable to the green and blue LEDs as well. Further, the present invention can be implemented in a four-color (red, green, blue and white) LED system as well as five-color LED system.

Electric current of different intensity is supplied to the R, G and B LEDs 161 installed on a plurality of regions by controlling the duty ratio, so that colors having different purity and brightness can be implemented according to each region. Meanwhile, the R, G and B LEDs 161 installed within a specific region of the LED unit 160 can independently emit monochromatic light having various degrees of brightness because they are independently controlled by different PWM controlling units. Accordingly, a variety of grey scales can be implemented by controlling brightness of each of the R, G and B LEDs 161.

As described so far, embodiments of the present invention can achieve the following effects by dividing a back light provided with LEDs into a plurality of regions and driving the LEDs according to independent signals. First, image quality can be improved by implementing R, G and B colors having spatially varying brightness by supplying different signals to R, G and B LEDs to each of the divided regions or having time varying brightness by supplying different R, G and B signals to a specific region. Second, a variety of grey scales can be implemented by the primary three colors having various brightness since brightness of the R, G and B colors can be controlled within the divided regions. Third, since an LED monochromatic light is used as a back light, a liquid crystal display panel has a relatively thin color filter layer for implementing a color. Thus, by reducing light absorption by the color filter layer, overall brightness of the liquid crystal display device can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A liquid crystal display device comprising:
a liquid crystal display panel;
a light source having red, green and blue light emitting devices for supplying light to the liquid crystal display panel, the light source being divided into a plurality of regions; and
a driving unit for separately driving red, green and blue light emitting devices in each region.

2. The device of claim 1, wherein the light source is divided into 32 regions.

3. The device of claim 1, wherein the driving unit comprises:
a timing controlling unit for generating a timing signal according to a video signal; and
a pulse width modulation controlling unit for outputting driving signals to the red, green and blue light emitting devices for each region according to the timing signal inputted from the timing controlling unit.

4. The device of claim 3, wherein the driving signals supplied to the light emitting devices of each region have different duty ratios.

5. The device of claim 1, wherein the red, green and blue light emitting devices are spatially-independently driven.

6. The device of claim 1, wherein the red, green and blue light emitting devices are temporally-independently driven within a region.

7. The device of claim 1, wherein the liquid crystal display panel comprises:
a first substrate having a switching device and an electrode pattern thereon;
a second substrate having a color filter layer thereon; and
a liquid crystal layer between the first substrate and the second substrate.

8. A liquid crystal display device comprising:
a liquid crystal display panel;
a light source formed of red, green and blue light emitting devices for supplying light to the liquid crystal display panel; and
a driving unit for locally controlling brightness of red, green and blue colors by locally and independently driving red, green and blue light emitting devices of the light source.

9. The device of claim 8, wherein the light source is divided into 32 local regions.

10. The device of claim 8, wherein the driving unit comprises:
a timing controlling unit for generating a timing signal according to a video signal; and
a pulse width modulation controlling unit for outputting driving signals to the red, green and blue light emitting devices according to the timing signal inputted from the timing controlling unit.

11. The device of claim 10, wherein the driving signals supplied to the light emitting devices have different duty ratios.

12. The device of claim 8, wherein the red, green and blue light emitting devices are spatially-independently driven.

13. The device of claim 8, wherein the red, green and blue light emitting devices are temporally-independently driven.

14. The device of claim 8, wherein a first driving signal with a first duty cycle is applied to one of the red, green and blue light emitting devices and a second driving signal with a second duty cycle is applied to an adjacent light emitting device adjacent to the one of the red, green and blue light emitting devices.

15. The device of claim 8, wherein a first driving signal with a first duty cycle and a second driving signal with a second duty cycle are sequentially applied to one of the red, green and blue light emitting devices.

16. A liquid crystal display device comprising:
a liquid crystal display panel;
a light source having at least three different colors of light emitting devices for supplying light to the liquid crystal display panel;
a driving unit for locally controlling brightness of the at least three different colors of light emitting devices, the driving unit including a timing controlling unit for generating a timing signal according to a video signal; and
a pulse width modulation controlling unit for outputting driving signals to the at least three different colors of light emitting devices according to the timing signal inputted from the timing controlling unit.

17. The device of claim 16, wherein the light source is divided into 32 local regions.

18. The device of claim 16, wherein the driving signals supplied to the light emitting devices have different duty ratios.

19. The device of claim 16, wherein the at least three different colors of light emitting devices are spatially-independently driven.

20. The device of claim 16, wherein the at least three different colors of light emitting devices are temporally-independently driven.
